(19) United States
(12) Patent Application Publication
(10) Pub. No.: US 2024/0256968 A1
(43) Pub. Date: Aug. 1, 2024

(54) SYSTEM AND METHOD FOR AUTOMATED UNDERWRITING FOR APPLICATION PROCESSING USING MACHINE LEARNING MODELS

(71) Applicant: THE TORONTO-DOMINION BANK, TORONTO (CA)

(72) Inventors: RASA HOSSEINZADEH, TORONTO (CA); KEYVAN GOLESTAN IRANI, NEWMARKET (CA); JEAN-CHRISTOPHE BOUËTTÉ, MONTREAL (CA)

(21) Appl. No.: 18/429,050

(22) Filed: Jan. 31, 2024

Related U.S. Application Data
(60) Provisional application No. 63/442,709, filed on Feb. 1, 2023.

(51) Int. Cl. G06N 20/00

(52) U.S. Cl. CPC G06N 20/00

(57) ABSTRACT

Embodiments of the present disclosure may include an application processing system including at least one processor and at least one memory configured to implement a deployed learning model, the deployed learning model generated via training a set of N machine learning models using a dataset of labelled features and values gathered across a network from input on an electronic user interface relating to applications. In some embodiments, the labelled features indicates a processing metric for the dataset, the dataset split into N folds for predicting straight through processing, each model trained on all but one fold of the dataset and tested on other remaining fold of the dataset. In some embodiments, the models may be tested on non-overlapping datasets and repeated until all models may be trained and deployed for determining straight through processing of new incoming applications.

### CROSS REFERENCE TO RELATED APPLICATIONS

This application claims benefit and priority of U.S. Provisional Patent Application Ser. No. 63/442,709 filed on Feb. 1, 2023, and entitled “SYSTEM AND METHOD FOR AUTOMATED UNDERWRITING AND APPLICATION PROCESSING USING MACHINE LEARNING AND ARTIFICIAL INTELLIGENCE MODELS”, the entire contents of which are incorporated herein by reference.

### FIELD

The present disclosure relates generally to the field of application processing and more particularly to improved machine learning based systems and methods for automated underwriting for application processing.

### BACKGROUND

Conventional methods for processing applications, particularly in scenarios such as term life insurance, have been predominantly manual, resulting in notable time delays and high operational costs. A significant portion of these applications undergo extensive manual processing, with a substantial percentage ultimately being discarded without further progression.

Current technologies for processing applications suffer from inconsistencies in data, often resulting in inaccuracies and incomplete information. In scenarios like term life insurance as an example, the known data available may also be limited in volume thereby making application processing a computationally difficult task.

Acknowledging these limitations, the existing methods predominantly rely on manual processing, which introduces subjective biases and increases the risk of errors. Furthermore, the inconsistency in the format and content of the data used in the applications, as well as the sparsity of known data collected through user input such as via online questionnaires exacerbate the challenge of data standardization and unified analysis.

### SUMMARY

Given the constraints of inconsistent and limited or sparse data, at least in terms of limited annotated or labelled data that is known to be correct for training/testing models and the fact that data gathered for various features may be gathered via various data sources (e.g. online questionnaires, social media websites, online data gathered for individuals relating to an application, various data sources across a network) having incomplete content and inconsistent formatting, the need for advanced computational models becomes apparent for accurate and automated machine based application processing. It is also apparent that partial automated techniques of using rule based approaches for automated processing do not address the data challenges of inconsistent and sparse known data and are unable to consistently provide accurate results.

The proposed machine learning models conveniently and effectively handle sparse datasets (e.g. sparse labelled dataset of known values or ground truth related to the applications) having a variety of data formats (e.g. online questionnaires, online data sources, application interface inputs with categorical, binary or other types of inputs) while mitigating the risk of inaccurate assessments. Thus, the proposed disclosure provides a system for deploying machine learning-driven approaches to enhance the accuracy and efficiency of application processing workflows, such as in a networked underwriting system processing large amounts of application data (e.g. big data).

In at least some aspects, the present disclosure pertains to the field of computational data processing and automated decision systems. Specifically, it relates to the development and implementation of improved machine learning-driven automated underwriting systems for application processing (including proactive predictive data-driven systems for determining whether to allow or deny transactions) across various domains, including insurance, finance and other industries requiring efficient evaluation and categorization of application data.

In at least some aspects, there is provided an application processing system comprising: at least one processor and at least one memory configured to implement a deployed learning model, the deployed learning model generated via training a set of N machine learning models using a dataset of labelled features and associated values gathered across a network from input on an electronic user interface relating to applications and wherein the labelled features indicates a processing metric for the dataset, the dataset split into N folds for predicting straight through processing, each model of the set of machine learning models is trained on all but one fold of the dataset and tested on other remaining fold of the dataset, wherein the models are tested on non-overlapping datasets and repeated until all models are trained wherein a resultant model providing the deployed learning model is generated by aggregating results via model ensembling from training each said model of the set of machine learning models, the at least one processor further configured to: automatically process a first input on the electronic user interface having a plurality of associated features for a first underwriting application using the deployed learning model to generate a first processing metric for the first input; apply the first processing metric to a decision module having a defined threshold for straight through processing and responsive to the first processing metric exceeding the defined threshold, the at least one processor further configured to: process via applying straight through processing, using the at least one processor, the first underwriting application; and sending, to a computing device associated with the first underwriting application and based on processing the first underwriting application, a display to output a result of processing the first underwriting application.

In at least some aspects, there is provided a computer implemented method comprising: implementing a deployed learning model for predicting straight through processing of input applications and associated features, the deployed learning model generated via training a set of N machine learning models using a dataset of labelled features and associated values gathered across a network from input on an electronic user interface relating to applications and wherein the labelled features indicate a processing metric for the dataset, the dataset split into N folds for predicting straight through processing, and each model of the set of machine learning models is trained on all but one fold of the dataset and tested on other remaining fold of the dataset, wherein the models are tested on non-overlapping datasets and repeated until all models are trained and wherein a resultant model providing the deployed learning model is generated by aggregating results via model ensembling from training each said model of the set of machine learning models; automatically processing a first input on the electronic user interface having a plurality of associated features for a first underwriting application using the deployed learning model to generate a first processing metric for the first input; applying the first processing metric to a decision module having a defined threshold for straight through processing and responsive to a determination of the first processing metric exceeding the defined threshold: processing via applying straight through processing, using an application processing module, the first underwriting application; and sending, to a computing device associated with the first underwriting application and based on processing the first underwriting application, a display to output a result of processing the first underwriting application.

In at least some aspects, during generating of the deployed learning model, the at least one processor is further configured to perform feature ablation to determine features of interest and ablate remaining features via k-fold cross validation using holdout of a selected feature at a time, wherein each model is tested on a single fold which it was not trained on while removing one feature at a given time from a training and testing dataset provided in the dataset of labelled features and aggregating results to determine performance of models trained on data with the one feature removed via a performance metric and applying a defined feature threshold to the performance metric to determine features of interest having a highest performance metric.

In at least some aspects, the at least one processor is further configured to perform hyperparameter optimization using k-fold cross validation performed after feature ablation on only non-ablated features.

In at least some aspects, the dataset of features is selected from at least one of: binary, categorical and numerical data input into the electronic user interface of an associated computing device accessing an application programming interface.

In at least some aspects, the at least one processor is further configured, to apply the first underwriting application to a rule based decisioning model to determine, via applying a defined set of rules to associated features of the dataset of the first underwriting application, an initial indication of whether to further process the first underwriting application via the deployed learning model; based upon a positive response for further processing, the at least one processor is configured to provide the first underwriting application to the deployed learning model for predicting straight through processing.

In at least some aspects, the at least one processor is further configured to train the set of machine learning models based on a new dataset of labelled features and compare performance to a prior iteration to determine which instance of the machine learning models to utilize based on increased relative performance.

In at least some aspects, the at least one processor is further configured to confirm validity of the deployed learning model by applying out of time data as a test set and averaging prediction results from each of the set of machine learning models to determine a prediction score.

In at least some aspects, each of the set of machine learning models utilizes a supervised extreme gradient boosted (XGBoost) model.

In at least some aspects, the set of machine learning models comprises 5 models and a same threshold is applied to all models to determine whether to apply straight through processing to the first underwriting application.

In at least some aspects, performing the hyperparameter optimization further comprises the at least one processor configured to apply Bayesian optimization for hyperparameter tuning of each said model of the set of machine learning models.

In at least some aspects, the at least one processor is configured to apply a plurality of decision trees via an XGBoost model to determine the defined threshold at the decision module.

In at least some aspects, the at least one processor further converts the first input on the electronic user interface to a comma separated value file having a similar format of features to the dataset of labelled features used for training the set of machine learning models prior to applying to the deployed learning model.

### BRIEF DESCRIPTION OF THE DRAWINGS

These and other features will become more apparent from the following description in which reference is made to the appended drawings wherein:

FIG. 1 is a block diagram illustrating an application processing system, according to some embodiments of the present disclosure.

FIG. 2 is a block diagram illustrating an underwriting platform for the application processing system of FIG. 1, according to some embodiments of the present disclosure.

FIG. 3A is a block diagram illustrating a flow of operations of computing components during model training and evaluation of the machine learning module of FIGS. 1 and 2;

FIG. 3B is a block diagram illustrating a flow of operations of computing components during model deployment of the machine learning module of FIGS. 1 and 2, according to some embodiments of the present disclosure.

FIGS. 4A, 4B, 5A, 5B and 6 illustrate various performance metrics and schematics for the final model as generated by FIGS. 1-3A and 3B.

FIG. 7 is a flow diagram of a process according to some embodiments of the present disclosure.

### DETAILED DESCRIPTION

Embodiments of the present disclosure may include an application processing system including at least one processor and at least one memory configured to implement a deployed learning model, the deployed learning model generated via training a set of N machine learning models using a dataset of labelled features and values gathered across a network from input on an electronic user interface relating to applications.

In some embodiments, one or more of the labelled features indicate a processing metric for the dataset (e.g. straight through processing, declined, rerouting), the dataset split into N folds for predicting straight through processing, each model trained on all but one fold (e.g. N−1 fold) of the dataset and tested on the other remaining fold(s) (e.g. 1 fold) of the dataset. In some embodiments, the models may be tested on non-overlapping datasets and repeated until all models may be trained.

In some embodiments, a resultant model providing the deployed learning model may be generated by aggregating results from training each of the set of machine learning models, the at least one processor configured to automatically process a first input on the electronic user interface having a plurality of features for a first underwriting application using the deployed learning model to generate a first processing metric for the first input.

Embodiments may also include applying the first processing metric to a decision module having a defined threshold for straight through processing and responsive to the first processing metric exceeding the defined threshold, processing the first underwriting application. Embodiments may also include a display to output the first underwriting application and associated first processing metric.

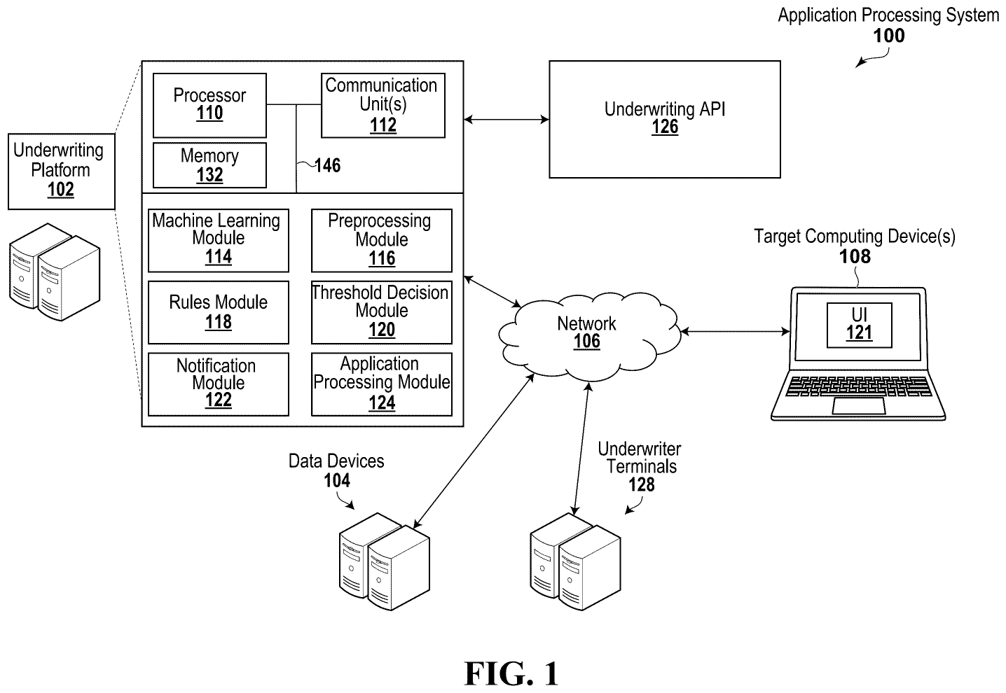

FIG. 1 is a block diagram that illustrates an application processing system 100, according to some embodiments of the present disclosure such as for example use in approving, denying or rerouting applications received across the distributed system. In some embodiments, the application processing system 100 may comprise an underwriting platform 102 having an associated underwriting application programming interface (API) 126, accessible via a target computing device 108 and/or data devices 104 and/or underwriter terminals 128. The underwriting platform 102 as described herein for performing automated adjudication and processing of applications including straight through processing, in real time, as described herein via machine learning models specifically configured, such as to handle challenges of underwriting data including sparse sets of training data (e.g. sparse known labelled or annotated data), inconsistent data (e.g. as a result of different formats of application data gathered such as different user interfaces or as a result of erroneous input of information into features or fields of data for each application) which may have been received via one or more online questionnaires, surveys or other user interface inputs relating to applications, such as via a target computing device 108 (e.g. via a user interface (UI) 121 accessing underwriting API 126) and/or data devices 104. The underwriting platform 102 may thus include a plurality of machine learning models trained, such as via data sources of underwriting data communicated across the network 106 such as via data devices 104 (e.g. containing data features for responses to one or more online forms or questionnaires relating to underwriting applications as may have been presented via underwriting API 126 on the user interface 121 of one or more target computing devices 108), underwriter terminals 128 (e.g. containing features relating to responses or underwriting results of prior applications and used as ground truth or known labelled data sets) and other underwriting communications used across the network 106, which may be collected via the underwriting platform 102 for training, testing, validating and deploying one or more machine learning models such as to subsequently predict likelihood of straight through processing or decline or further review of new incoming applications, as may be received via underwriting API 126 from target computing devices, including target computing device 108, via a user interface 121 presented thereon.

In at least some embodiments, there is provided an automated application approval and processing system (shown as system 100) as illustrated in FIG. 1 that incorporates machine learning with automated feature engineering using an ensemble of models to assess a variety of electronic information communicated across a network to make approval decisions fully electronically and without manual intervention (e.g. straight through processing).

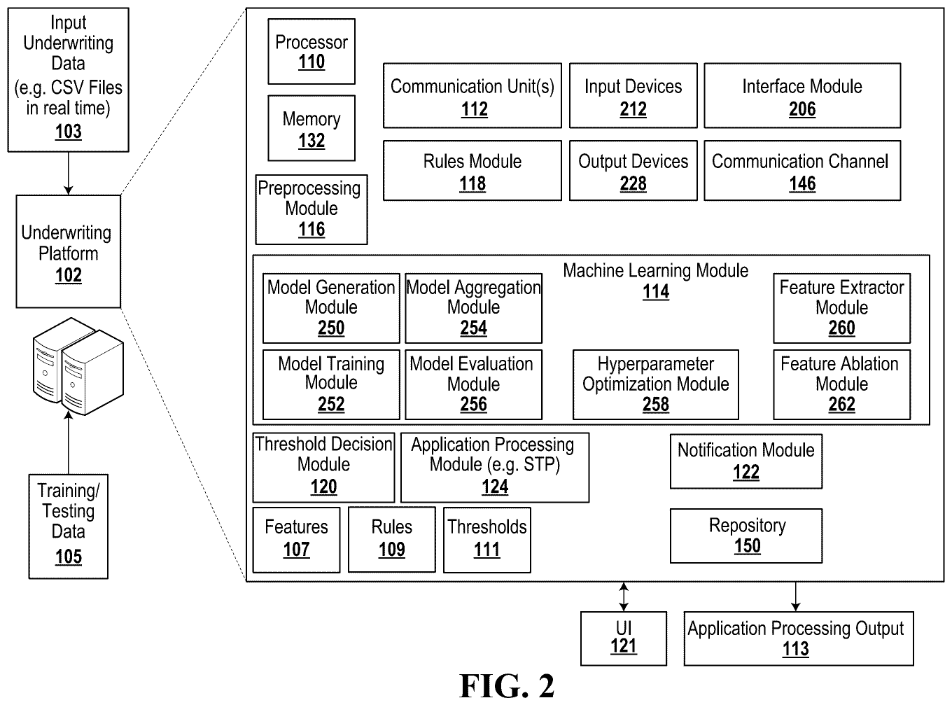

Referring to FIGS. 1 and 2, the application processing system 100 provides, via an underwriting platform 102, an adjudication and processing automation model for online products, such as underwriting applications and can instantaneously generate decisions regarding applications communicated across the network 106. Conveniently, the underwriting platform 102 needs no manual intervention and minimal processing resources as it standardizes data received or ingested from multiple data sources (e.g. via a preprocessing module 116 which may convert data from multiple online surveys, questionnaires, web sources or user interface elements to a standard common format to be ingested by the machine learning model) and generates multiple machine learning models via sparse training/testing data (e.g. via a machine learning module 114) while managing security risk to generate decisions (e.g. via a threshold decision module 120). Further conveniently, in at least some aspects, the underwriting platform 102 implements a machine learning prediction model (e.g. provided via a machine learning module 114) on top of a set of rules-based decisioning models (e.g. provided via a rules module 118), which allows the system of FIG. 1 to increase straight through processing rate (e.g. as provided via a threshold decision module 120 and an application processing module 124) and improve the cycle time while routing denied and/or unapproved cases for further analysis which may be communicated via a notification module 122 to other computing devices of the system 100 such as underwriter terminals 128 for additional underwriting processing.

Generally, and as an example, applying only rules based decisioning as a standalone to determine which applications to approve or deny, such as applying rules to automatically approve some applicants (e.g. applicants meeting certain criteria such as clean medical history in the sense of term life insurance applications) and their applications while denying others based on the rules, and forwarding to evaluation by underwriters has certain drawbacks. Namely in this scenario, manual evaluation and consideration by an underwriter is a costly process. Additionally, the rules based decisioning systems as standalones are incapable of holistically looking at a large and diverse set of features that identify the underlying data in application transactions, or their complex interrelationships and also unable to account for data drift and changes in characteristics of data and associated features, thereby leading to inaccuracies and inconsistencies as well as additional processing needed to correct the errors presented by standalone rules.

Additionally, such standalone rules require manual adjustment and alterations and may be out of data and out of sync with current patterns and behaviours of data communicated across the network, such as shown in FIG. 1. Thus, in at least one aspect, the application processing system 100 generates and provides a machine learning model (which may be provided alone or in collaboration with a rules based system, such as rules module 118), such as provided in the underwriting platform 102 of FIGS. 1 and 2 that can evaluate each application for straight through processing without manual intervention, while holistically capturing a multitude of features of applications and their interrelationships while optimizing straight through application processing thereby to increase accuracy, reduce overhead and reduce processing power needed and automating the approval and processing of an increased number and only redirecting those applications that do not meet the metrics of the machine learning models of the underwriting platform (e.g. redirecting only a small fraction) for further analysis, such as via underwriter terminals 128. The automated portion may be referred to as straight through process (STP). Put another way, straight through processing of applications, is by way of example, a system that processes electronic transactions or data transfers between devices fully electronically, speeds up electronic transactions and interactions by processing them without manual intervention and allows automated processing of such transactions (e.g. may involve transfer of data between accounts, payment processing, or electronic transfers). While straight through processing may be discussed in some examples in terms of insurance and financial data or applications, other types of technical scenarios such as electronic processing applications or electronic data transfer between computing devices may be envisaged such as but not limited to e-commerce and online websites of merchants, electronic authentication, streamlining data sharing across multiple data points and data sources, and enabling automatic exchange of data or information between computing devices across a network to allow settlement, etc.

In at least some aspects, an example measure of the performance of the application processing system 100 and particularly the underwriting platform 102 may be captured via STP (straight through processing) rate and misclassified decline rate. STP rate is the number of standard cases that a model classifies as STP divided by the number of all cases (prior to application of rules). The misclassified declines rate is the number of declines that are classified as STP divided by the number of standard cases classified as STP. Such performance metrics may be calculated by the underwriting platform 102, such as via the model evaluation module 256 of FIG. 2.

Referring to FIGS. 1 and 2, machine learning models may be used within the underwriting platform 102 with various thresholds corresponding to how conservative the model is in predicting straight through processing of applications (or decline of applications or rerouting of applications for further processing). The machine learning models generated in the underwriting platform 102 may at a high level be evaluated by the model evaluation module 256 determining an evaluation metric for checking the classification model's performance as Area Under Receiver Operating Characteristic, ROC (AUROC). In general, ROC is a probability curve and Area Under ROC represents a degree or measure of separability and defines how well the classification model (e.g. model generated by the machine learning module 114) is capable of distinguishing between classes (e.g. STP, decline, rerouting of applications). In at least some applications, the model evaluation module 256 incorporates that a cost of misclassifying a declined case is higher than misclassifying a standard case; thus a threshold (e.g. threshold 111) may be selected in a conservative way to minimize the misclassified decline rate while keeping the STP rate at a desired level.

FIG. 2 illustrates a more detailed block diagram of example computing components of the underwriting platform 102 shown in FIG. 1 for performing straight through processing prediction, evaluation and implementation via a set of machine learning models, being trained specifically and generated in a particular manner to handle real-time incoming application data.

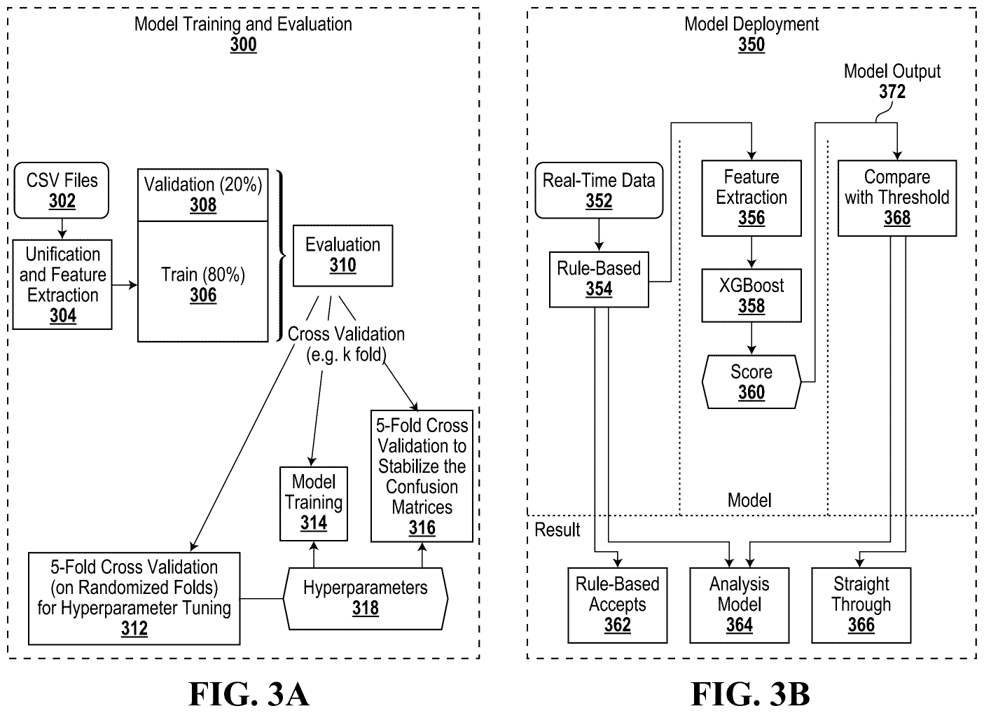

Conveniently, the deployed machine learning models are specifically configured and trained/tested to handle challenges in the training/testing data set which may occur for data communicated across the network 106 of the application processing system 100 such as from data sources including data devices 104, e.g. sparse training/testing dataset and variances in the formats of data that are provided from the system for the training/testing dataset. Further inconsistencies in the data may occur due to data drift or online form data used for datasets having inconsistencies in lacking some fields of attributes. Other data inconsistencies may include the values of certain fields or attributes of the input data being different formats such as numerical, binary or categorical and thus need to be unified via the underwriting platform (e.g. see unification step 304 in FIG. 3A). Other inconsistencies in the data which may need to be accounted for include insufficient labelled data to be used for training the model, etc. As described herein, the machine learning models generated in the underwriting platform 102 are configured to conveniently address these data challenges in one or more embodiments via a particularly trained, tested, and optimized set of machine learning models generated by the machine learning module 114 as will be described with reference to FIGS. 1, 2, 3A and 3B.

FIGS. 3A and 3B illustrate schematic flow diagrams of example flow of operations and computing processes occurring in the underwriting platform 102 during model training and evaluation (FIG. 3A) for training and evaluating the machine learning models to be deployed (e.g. via the machine learning module 114 of FIG. 2) such as during training, testing and generating the machine learning models; as well as example flow of operations and processes during machine learning model deployment (e.g. during inference of applying the deployed machine learning model to new incoming real-time application data) as shown in FIG. 3B.

Referring to FIGS. 1-3A, and 3B, in one example, inputs to the machine learning models in the underwriting platform 102, such as the machine learning module 114, may be provided via a variety of available data sources that provide information about each application such as application metadata (e.g. application information as completed via a user interface of an underwriting application); applicant information, applicant characteristics, characteristics and nature of the application and other features used to determine whether a particular application should be automatically processed and approved (e.g. low risk applicant). Example of data sources may include but are not limited to, online application portals, application related websites, underwriting portals, social networking sites, public data sources, etc. Example of inputs are shown in FIGS. 2-3 as input underwriting data 103; training/testing data 105; training data or CSV files at step 302; and real time data at step 352.

In one example, the data input to the machine learning models (e.g. the machine learning module 114) may be provided by one or more online questionnaires relating to the underwriting application (e.g. as provided in the underwriting API 126) which may change over time due to various providers.

Additionally, in one or more aspects, the available labelled data for use by the machine learning model of the machine learning module 114 may be sparse and contain inconsistent data (e.g. only limited to thousand(s) of data records). In one or more examples, the format of the questionnaire, online survey, user interface input, social media input, web source input, application programming interface input or other application data input may also be changed over time when the training data is collected (e.g. from data sources such as data devices 104) and measures may be performed, via the preprocessing module 116 to address this data challenge and unify the format of the data to a consistent format to train a machine learning model that is able to use both old and new data. The preprocessing module 116 may further be configured to filter out irrelevant data, such as data records (e.g. rows or columns of the data) from the input underwriting data 103 received in real time or the training/testing data 105 set that is used to train the machine learning models of the machine learning module 114 for straight through application processing determination.

The following is an example of preprocessing and filtering performed by the preprocessing module 116 to reduce application records to be reviewed to relevant cases:
The ‘statuskey’ may be updated to be either ‘approvedInforce’ or ‘decline’. This may reduce the number of records.
The case must be for a term application i.e. ‘productkey’. This may reduce the number of cases.
Finally joining two questionnaire files and dropping all the cases without any answers may reduce the number of records.

As noted in one example and referring to FIGS. 1, 2, 3A and 3B, features from online questionnaire(s) available for the underwriting application (e.g. features identifying the applicant and the application request to be processed such as for an insurance application or e-commerce application) as input into various user interfaces such as on websites or underwriting application programs (e.g. as input on UI 121 displayed on the target computing device(s) 108 or stored on data devices 104) and underwriting results on whether the application is previously approved, denied or further processed (e.g. via underwriter terminals) may be collected across the network 106 via the underwriting platform 102 and used as input data set of application features and values including prior application processing status (e.g. training/testing data 105) for training/testing/validating the machine learning models of the machine learning module 114 to determine the target variable and predict whether an application should be straight through processed, denied (as may be reported to target computing device 108 on the UI 121) or routed to other computing devices in the application processing system 100 for further analysis and review across the network 106.

In at least some aspects, the machine learning module 114 implements a specifically configured Extreme Gradient Boosting algorithm (XGBoost) as its machine learning backbone (e.g. using multiple models as described herein which are cross validated with one another for a variety of purposes to utilize the sparse training/testing data and aggregated together for implementation). Conveniently, the training and inference process utilizing the multiple models applying XGBoost is fast and efficient as is crucial for models that need to run within a short period of time and provide real time dynamic analysis of applications to be processed.

Additionally, the models as generated by the machine learning module 114, as described herein which use a backbone of XGBoost configured as described herein and is robust to outliers and missing values, which results in a much easier data preprocessing step. Additionally, the generated machine learning model uses a backbone of XGBoost thereby allowing it to better handle diverse feature types (numeric, categorical, date, etc.).

The machine learning module 114 configures the output of the model as generated via the model generation module 250 of FIG. 2 to be a number between 0 and 1 (see also model output 372 of FIG. 3B) and thus shows the models “confidence” for the case being a standard case. The underwriting platform 102 uses this number output from the machine learning model (see compare with threshold at step 368 of FIG. 3B), via the machine learning module 114, to compare it to a threshold (e.g. threshold 111 of FIG. 2) to determine whether to allow a case via straight through processing, deny the application or reroute the application for further processing, such as via underwriter terminals 128.

In one or more aspects, the machine learning module 114 is further configured to measure the set of models' performance based on a defined threshold which makes the STP rate equal to a desired level. Note that, in at least some aspects, this threshold value may be determined for the threshold decision module 120 (e.g. threshold 111) by cross validation, i.e. the data is split into 5 folds and then each fold is treated as a hold out (e.g. a single fold is held out or withheld from the model during the training process but rather reserved for evaluating the model's performance) such the model is trained on the remaining 4 folds and the 5 runs are aggregated to produce the final result. In one or more aspects, one or more models generated by the model generation module 250 share a similar threshold 111.

Referring to FIGS. 3A and 3B, shown in block diagram schematic is an overall architecture for training and deployment of the machine learning models as may be implemented by the underwriting platform 102 of FIGS. 1 and 2, and particularly the machine learning module 114 components.

As illustrated in operations of FIG. 3A depicting the model training and evaluation phase 300 as may be implemented via one or more modules of the machine learning module 114 and the processor 110, in cooperation with one or more modules of the underwriting platform 102. At step 302, training data is provided to the machine learning module 114 (e.g. via polling, pulling or listening to historical application data and straight through processing probability results communicated across the system of FIG. 1) in multiple CSV files at 302. Table 1 is an example of various data sources used for training and testing the model for a particular term life underwriting insurance application. Other types of applications may be envisaged.

TABLE 1
Features and Sources (Each entry contains features from one file)

| Feature set | Explanation |
|---|---|
| Case | Features about the case, mostly used for determining |
| | target and filtering the data |
| Applicant | Citizenship from this file is used to filter the data |
| | as a rule. |
| Health | The largest file with most of the features that are |
| Questionnaire | used for input. |
| MIB (Medical | A feature that is collected from third party data |
| Information | sources and may be used for filtering and evaluation |
| Bureau) | purposes |

At step 304 of FIG. 3 and with reference to FIG. 2, the underwriting platform 102 manipulates input training/testing data 105 to undergo unification and feature extraction for preparation for the model training (e.g. via preprocessing module 116 and feature extractor module 260). This may include selecting feature sets that are common and not null for all versions of the input data. In some aspects, In order to unify multiple versions of data, the intersection of available options in the two versions were used.

Following step 304, the training/testing data 105 split is performed by the underwriting platform 102 to have a training data 306 that comprises 80% of the available data samples and testing data 308 that comprises 20% of the available data samples. Thus given a training/testing data sample set of 100 data points of input, the model training module 252 will train the model on 80 data samples and test on 20 data samples. This is performed 5 times as described earlier (e.g. see step 314 illustrating model training) by switching the testing and training dataset while keeping the ratios of the split between the data the same. As described, the k fold cross validation is further applied, by the model generation module 250 to multiple different applications for generating the model in the model training and evaluation phase 300 of the model by the model generation module 250 such as to satisfy challenges with the given training data set including the limitations of the amount of data samples being low and incompatible formats may be obtained of the data across various data sources. Such uses may include 5 fold cross validation applied at step 312 on various randomized folds for hyperparameter tuning to generate hyperparameters 318 which are optimally tuned. Additionally, the k fold cross validation may be applied by the model generation module 250 in yet a further iteration at step 316 to stabilize the confusion matrices. Additionally, at step 310, the model generated by the model generation module 250 of FIG. 2 may be evaluated such as via 5 fold cross validation being applied on all of the data again. In inference, the logits from all 5 models will be averaged and then transferred to probability space (via sigmoid), which will be the final score.

Referring now to FIG. 3B, during the model deployment phase 350, real time application data and features may be received at step 352 (e.g. see input underwriting data 103 in FIG. 2) for application to the machine learning module 114. As noted earlier, the machine learning module 114 may generate a set of machine learning models having a binary classification task on tabular data using extreme gradient boosting, a tree based gradient boosting model with regularization. The model is also configured to calculate the feature importance by aggregating the gain caused by feature in various trees.

In an optional step, rule based metric and logic may be applied at step 354 (e.g. rules 109 via rules module 118) to determine initial routing of the input data. Examples of results may include rules based accept of the application at step 362, or providing to additional computing devices for analysis at step 364. At step 356, a set of defined features may be extracted such as via feature extractor module 260. Such features may be determined at the training phase based on feature ablation and determining features that are of high importance to the target variable. The extracted features are then applied at step 358 via the machine learning module 114 to the generated model (e.g. from FIG. 3A) shown as a customized and specifically configured implementation of machine learning model using XGBoost which generates a score at step 360 indicative of a probability of being automatically approved. For example, in the case of underwriting applications, the quantity or score being estimated or predicted by the model is the likelihood of a policy being approved and put in force. Such score is compared to a defined threshold (e.g. threshold 111 of FIG. 2) at step 368 (e.g. via a threshold decision module 120). If the confidence score is greater or equal to the selected threshold, the system (e.g. the underwriting platform 102) will instantly and completely electronically automatically approve the application (e.g. straight through processing at step 366) and a notification and/or display may be generated on requesting computing devices of the distributed computing system such as a target computing device 108. If not, it will be sent for additional processing (e.g. step 364) such as communicated to underwriter terminals 128 across the communications network with notification about the resulting output score and confidence level.

In at least some aspects, the set of machine learning models implemented by the machine learning module 114 of FIGS. 1-3B perform cross validation for training/testing, performance evaluation and reporting (e.g. via the model evaluation module 256) to account for low number of cases in training/testing data 105 set which may cause the performance metrics to have high variance. In order to have a larger set for performance evaluation and to stabilize the metrics (i.e. reduce the variance) the model evaluation module 256 performs cross validation.

In at least some aspects and referring to FIGS. 1 and 2, by the underwriting platform 102 implementing the machine learning prediction model (e.g. via the machine learning module 114) on top of rules-based decisioning implemented via the rules module 118 and set of rules 109 which may be predefined, the underwriting platform 102 conveniently is able to increase the straight through processing rate while routing more complex cases or unapproved cases for additional processing via one or more associated computing devices.

As illustrated in FIG. 2, the underwriting platform 102 may include a number of computing modules or components, including one or more preprocessing module 116, rules module 118, machine learning module 114, threshold decision module 120, notification module 122, and application processing module 124. The underwriting platform 102, and processor 110 as well as modules of the underwriting platform 102, including preprocessing module 116, rules module 118, machine learning module 114 (and its various submodules 250-262), threshold decision module 120, application processing module 124 and notification module 122 may access information in one or more databases including features 107 data associated with previous underwriting applications including approved or declined status of applications and associated features (e.g. features identifying application and applicant information) as well as values for the features 107, rules 109 data associated with initial rules for determining whether to approve or deny applications or further processing via machine learning module 114, and threshold 111 data associated with thresholds for deployed machine learning models to implement such that when the threshold is exceeded for a particular application, it is indicative of an application to be straight through processed and when the threshold is not met, the application may be denied once applied to the machine learning module 114.

The underwriting platform 102 includes at least one processor 110 (such as a microprocessor) which controls the operation of the computer. The processor 110 is coupled to a plurality of components and computing components via a communication bus or channel, shown as the communication channel 146.

The underwriting platform 102 further comprises one or more input devices 212, one or more communication units 112, one or more output devices 228 and one or more machine learning models as may be generated via machine learning module 114. Underwriting platform 102 also includes one or more data repositories 150 storing one or more computing modules and components such as machine learning module 114 and subcomponents (e.g. model generation module 250, model training module 252, model aggregation module 254, model evaluation module 256, hyperparameter optimization module 258, feature extractor module 260, and feature ablation module 262); threshold decision module 120, application processing module 124, notification module 122, features 107, rules 109, thresholds 111 and application processing output 113.

Communication channels 146 may couple each of the components for inter-component communications whether communicatively, physically and/or operatively. In some examples, communication channels 146 may include a system bus, a network connection, an inter-process communication data structure, or any other method for communicating data.

Referring to FIGS. 1 and 2, one or more processors 110 may implement functionality and/or execute instructions as provided in current disclosure within the underwriting platform 102. The processor 110 is coupled to a plurality of computing components via the communication bus or communication channel 146 which provides a communication path between the components and the processor 110. For example, processors 110 may be configured to receive instructions and/or data from storage devices, e.g. data repository 150 and/or memory 132, to execute the functionality of the modules shown in FIG. 2, including the machine learning module 114 among others (e.g. operating system, applications, etc.).

Underwriting platform 102 may store data/information as described herein for the process of generating a plurality of machine learning models specifically configured for performing prediction of a likelihood of straight through processing and upon positive determination, applying straight through processing of applications which may be delivered to one or more computing devices, such as target computing device 108, by way of interface module 206. Some of the functionality is described further herein.

Memory 132 may represent a tangible and non-transitory computer-readable medium having stored thereon computer programs, sets of instructions, code or data to be executed by processor 110. One or more communication units 112 may communicate with external devices such as data sources, data devices 104, underwriter terminals 128, target computing devices 108 via one or more networks (e.g. communication network 106) by transmitting and/or receiving network signals on the one or more networks. The communication units may include various antennae and/or network interface cards, etc. for wireless and/or wired communications.

Input devices 212 and output devices 228 may include any of one or more buttons, switches, pointing devices, cameras, a keyboard, a microphone, one or more sensors (e.g. biometric, etc.) a speaker, a bell, one or more lights, etc. One or more of same may be coupled via a universal serial bus (USB) or other communication channel (e.g. 146).

The one or more data repositories 150 may store instructions and/or data for processing during operation of the application processing system and underwriting platform 102. The one or more storage devices may take different forms and/or configurations, for example, as short-term memory or long-term memory. Data repositories 150 may be configured for short-term storage of information as volatile memory, which does not retain stored contents when power is removed. Volatile memory examples include random access memory (RAM), dynamic random access memory (DRAM), static random access memory (SRAM), etc. Data repositories 150, in some examples, also include one or more computer-readable storage media, for example, to store larger amounts of information than volatile memory and/or to store such information for long term, retaining information when power is removed. Non-volatile memory examples include magnetic hard discs, optical discs, floppy discs, flash memories, or forms of electrically programmable memory (EPROM) or electrically erasable and programmable (EEPROM) memory.

Referring again to FIGS. 1 and 2, in the case of underwriting applications, the following is an example of features in the input underwriting data 103 to the machine learning module 114 and/or types of fields or features 107 (and associated values) within an application that are in the training/testing data 105 for the machine learning module 114:
Case: ‘ApplicationId’, ‘StatusKey’, ‘Rating’, ‘PerThousand’, ‘Application_CoverageAmount’, ‘age_at_application_date’, ‘ProductKey’, ‘CoverageAmount’.
Applicant: ‘ApplicationId’, ‘CitizenshipStatusKey’.
MIB: ‘ApplicationId’, ‘ResponseContents’, ‘MIBRequestStatusKey’.
Health questionnaire: Version of questionnaire and text of answers to questionnaire. (note that ‘ApplicationId’ column is used to determine whose answer is being processed):
   There are 3 types of inputs obtained based on the answer to these questions.
      1) Binary (including masked feature, used as indicator to providing the answer or not)
      2) Categorical
      3) Numerical

Initially and referring to FIGS. 1 and 2, the input underwriting data 103 providing real-time application data and training/testing data 105 relating to the applications, status of applications and other application features may be ingested by the underwriting platform 102 such as by polling or pulling sources of information from the various data sources such as data devices 104, underwriter terminals 128, target computing devices 108, etc. in the distributed system of the application processing system 100. This data may be ingested and saved in a repository 150 of the underwriting platform 102 in the form of CSV (comma separated value) files, e.g. as shown in step 302 of FIG. 3A. The preprocessing module 116, may be configured to extract features from the files such as to provide to the machine learning module 114 for training and testing of the models generated. Additionally, there may be different types of data sources as mentioned earlier with different types of questionnaires providing answers to questions and fields relevant to the application such as provided on the UI 121. Prior to processing by the model, the data may be unified by the preprocessing module 116 which may convert different types of data relating to the application to a format that the model can consume. Preprocessing module 116 may further replace or impute missing values from data; convert variables in one format (e.g. categorical) into another format (e.g. numerical) representation; perform feature scaling (i.e. scale feature so that they have similar ranges); or format data (e.g. prepare data in the form of feature matrix X and target vector Y where X contains the feature the model may be trained on and Y contains the corresponding target values.

Preprocessing module 116 may further encode the inputs as follows:
a. Binary features encoded as 0, 1 and nan (if no answers provided)
b. Numerical features remained the same.
c. Categorical features were turned into multiple features by having one feature for each option. In order to unify multiple versions the intersection of available options in two versions were used.

Additionally, in some optional aspects, the rules module 118 may apply a set of defined rules 109 to the input application data to have an initial indication of whether the application should be approved for straight through processing or denied or further examined and such information about the output of the rules module 118 may be provided to the machine learning module 114 as an additional aspect or feature (e.g. features 107) that the model may be trained upon via the model training module 252.

Referring to FIG. 2, the machine learning module 114 of FIG. 2 is configured to train, test, generate and deploy a set of machine learning models that automate underwriting application processing thereby to predict and determine subsequent actions for the application (e.g. straight through processing or deny application).

The set of predictive models generated by the machine learning module 114, in various implementations may include but not limited to supervised neural networks, XGBoost, random forest, or ensemble learning algorithms for supervised machine learning tasks. The machine learning module 114 utilizes a feature extractor module 260 to extract one or more relevant features 107 (e.g. as related to the target variable of predicting application processing action) from a training/testing data 105 for training the model via a model training module 252. In the training phase, due to the sparsity of cases that are available for training and testing data as well as data shift or drift which have occurred, the testing/training data 105 is not split based on version of the data (e.g. different versions of the input user interface inputs) or time of data record. Rather, due to the sparsity in the training/testing data available, the model generation module 250 cooperates with the model training module 252 such that instead of using a separate test set, the model generation module 250 applies k-fold cross validation, for the training/testing phase (e.g. see also training/testing phase 300 of FIG. 3A). The available training/testing data 105 ingested is split via the model generation module 250 into k folds and k different machine learning models are trained by the model training module 252 such that each model does not see one of the folds of the available data samples including feature 107 data related to the application processing during training (e.g. only sees k−1 folds) and is then tested on that remaining fold. The results are then finally aggregated via a model aggregation module 254, such as to ensemble the models. For example, ensemble learning applied by the model aggregation module 254 involves aggregating the predictions or decisions of the multiple machine learning models generated via the model generation module 250 to achieve better performance than any single model alone. One example implementation of the model aggregation module 254 is to perform simple averaging by combining the predictions of multiple models by taking the arithmetic mean of their predictions. Another example implementation of the aggregation module 254 is to perform weighted averaging for assigning weights to each model's predictions based on their performance or reliability and compute the weighted average.

Conveniently, this approach allows the model to generalize more by doing cross validation for feature ablation, for hyperparameter tuning and for model training (e.g. see model training and evaluation phase 300 in FIG. 3A).

Preferably, in one or more implementations, the number of models generated for training and testing the model is 5, such that k=5 fold training and testing may be performed.

The model training module 252 is further configured to train each of the multiple models generated such that given an input, the trained model calculates a probability of straight through processing (e.g. between 0 and 1).

The threshold decision module 120 may then be configured to apply a threshold 111 to the output generated by a trained model such that if the number of the output is higher than the threshold, the output is classified as straight through processing and appropriate processing applications may be performed by the application processing module 124 on the given application. Additionally, in at least some aspects, a notification module 122 communicates an output result, e.g. application processing output 113 of applying real time input data (e.g. 103) to trained machine learning models generated by the machine learning module 114 and comparing the result to the threshold 111 via the threshold decision module 120. For example, straight through processing applications are notified to one or more computing devices in the distributed system of FIG. 1, e.g. target computing device 108 such as by display of the straight through processing result on the UI 121. This may be communicated via one or more communication units 112 and across the network 106.

In one or more implementations, the model generation module 250 may be configured to perform feature ablation using cross validation. As will be described herein, the model generation module 250 applies cross validation for multiple purposes conveniently to address some of the shortcomings and challenges of the training/testing data 105 and the application data features (e.g. features 107).

Initially and referring to FIGS. 1, 2-3A and 3B, feature ablation may be performed by the model generation module 250 and the feature ablation module 262 by applying k-fold (e.g. 5 fold) cross-validation. To monitor the performance, each model is tested (e.g. see testing split at testing data 308 of FIG. 3A) on the fold that it was not trained (e.g. see training data 306 of FIG. 3A) on, via the model training module 252. The results may then be aggregated or ensembled for all the input dataset, e.g. training/testing dataset 105 (e.g. each row of data is in one fold, thus each row can be tested once). For example, at this point each row has a score coming from a model that has not seen the row while training. All of the performance metrics (ROC-curve, precision-recall, STP rate, etc.) are calculated using these scores via the model evaluation module 256. Note that preferably, a threshold (e.g. threshold 111) is shared between models.

Put another way, the feature ablation module 262 determines important features such as to ablate the rest of unimportant features from the features 107 in the training/testing data 105. In the current implementation, due to high number of features, testing all the combinations is infeasible. Therefore the model training module 252 trains a model (with default hyperparameters) and uses XGBoost feature importance and sorts each of the fields or attributes or features of the input training data (e.g. input training/testing data 105) based on importance. Then, by removing them one by one and performing k-fold cross validation, the feature ablation module 262 determines the performance of a model trained on the data with removed features. Finally, the data with the features removed that resulted in the best model is used. The metric for performance here may be set to AUC at defined percentage false positive. In one example, some features which may not be ablated are the following: Age; Application Coverage Amount; Questionnaire question; Prior denial of application; Product Key, etc.

In one or more implementations, the hyperparameter optimization module 258 performs hyperparameter tuning via k-fold (5-fold) cross-validation to tune hyperparameters. Conveniently, due to small size of the data test set (e.g. training/testing data 105) and in order to stabilize the test results, cross validation is applied. Thus, for each set of potential hyperparameters, the hyperparameter optimization module 258 performs one set of training/testing of the models and another set of hyperparameters is used for another set of training/testing of the models, and results are compared to one another to determine which set of hyperparameters provides an improved performance over the other and such hyperparameters are then used for training the final model.

For specification of hyper parameters via the hyperparameter optimization module 258, the training/testing data 105 may be split into k folds (the folds change for each hyper parameter) and k number of machine learning models trained and held out one fold of the hyperparameter set for each model and tested each model on the corresponding hold out set of the hyperparameter set. These results may then be aggregated via the model aggregation module 254 to obtain one ROC curve as a performance evaluator. Then the area under curve (AUC) was calculated for false positive rate less than a defined amount.

Due to large searching space, the hyperparameter optimization module 258 preferably does not utilize grid search; instead it applies Bayesian optimization for hyperparameter tuning. This method of optimization applied to hyperparameter optimization, uses statistical assumptions about hyper parameter space and balances exploration with exploitation in order to achieve optimal results using a reasonable amount of resources. At a high level, Bayesian optimization for hyperparameter tuning as applied by the hyperparameter optimization module 258 applies an optimization method, meaning that only by using function evaluations it can approximately find a maximum (or minimum) of a function. The hyper parameters include learning rate, number of trees and maximum depth of trees, and others may be envisaged. Note that this step is performed after feature ablation and only non-ablated feature are used during this process. Thus the model generation module 250 runs the hyper parameter optimization process described earlier to get the final set of hyperparameters.

Referring again to FIG. 2, once the model is generated, the model evaluation module 256 may be configured to perform model performance testing (e.g. see also testing data 308 of FIG. 3).

In at least some implementations, the final machine learning model performance is calculated by the model evaluation module 256 via k-fold cross-validation applied on all of the data set again. All of the performance metrics are calculated in the model evaluation module 256 as they were determined for feature ablation. In inference, the model generation module 250 is further configured to average the logits from all the k set of models (e.g. 5 models) and then transfer to probability space (via sigmoid), which will be the final score. The fold specific metrics are similar to each other, which justifies this averaging. Although the selection of k for the cross validation being k=5 is presented as an example, other variations of k may be set to 8, 10 or 100.

The model generation module 250 may perform out of time testing via the model evaluation module 256 with out of time data as the test set. The same preprocessing as the training data is performed. This time all five models provide their prediction and by averaging in logit space, the evaluation module gets the final result which is used to calculate metrics like AUROC (Area Under the Receiver Operating Characteristic curve which is a metric used to evaluate the performance of a classification model), and AUPR (Area Under the Precision-Recall curve which is another metric used to evaluate the performance of a binary classification model, particularly in cases where the classes are imbalanced.), etc.

The model's performance may be measured based on two metrics: Straight Through Processing rate (STP rate) and Misclassified Decline rate (MD rate) which are described in the following paragraphs.

STP rate: The number of standard cases that a model classifies as STP divided by the number of all cases (prior to application of rules). A higher STP rate is desired. Note that “all cases”, refers to all standard cases prior to dropping the rule based decisions.

MD rate: The number of declines that are classified as STP divided by the number of standard cases classified as STP. A lower MD rate is desired.

Note that for both of these metrics only declined and standard classes matter and the rest of the cases (belonging to classes like reduce) do not matter.

There is a trade-off between these two rates. Notably, by changing the threshold (e.g. threshold 111), the model classifies more cases as STP as it increases STP rate and usually (but not always) also increases MD rate (i.e. the increase of standard STPs is less than the increase of declined STPs) and vice versa. The initial threshold may be predefined.

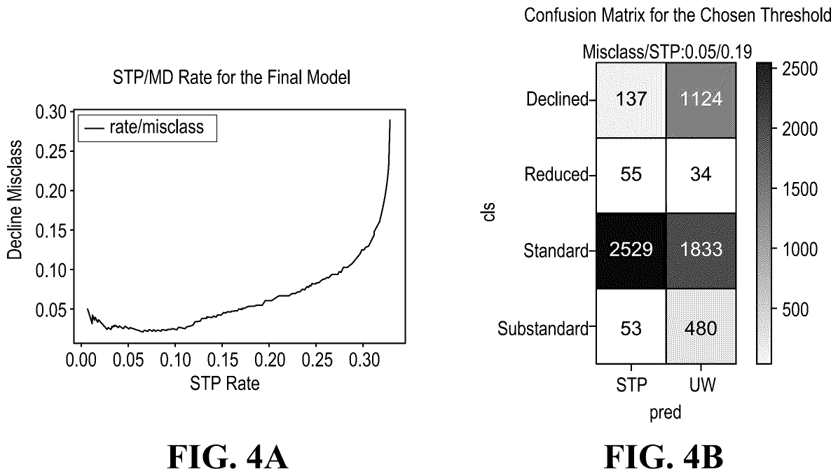

FIGS. 4A and 4B illustrate performance schematics of a straight through processing (STP)/misclassification rate for the final model (FIG. 4A) and confusion matrix for the chosen threshold (FIG. 4B) as determined by the model evaluation module 256. FIG. 4A depicts the tradeoff between STP rate and MD rate by changing the threshold 111 of FIG. 2.

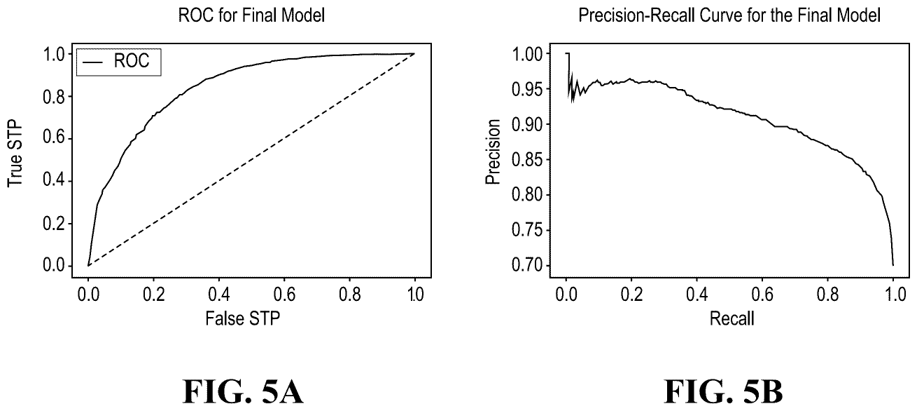

FIGS. 5A and 5B illustrate additional performance metrics calculated by the model evaluation module 256 for the final model including ROC for final model (FIG. 5A) and Precision recall curves for the final model (FIG. 5B).

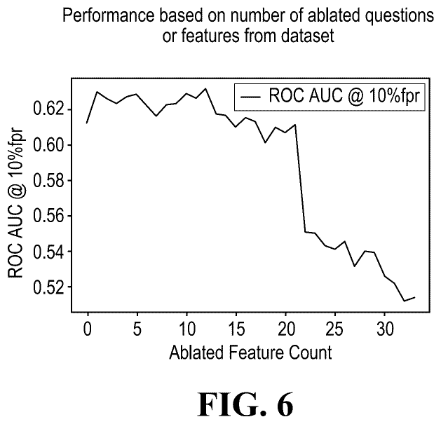

FIG. 6 illustrates an additional example schematic of the performance of an example model based on the number of ablated features or attributes or questions.

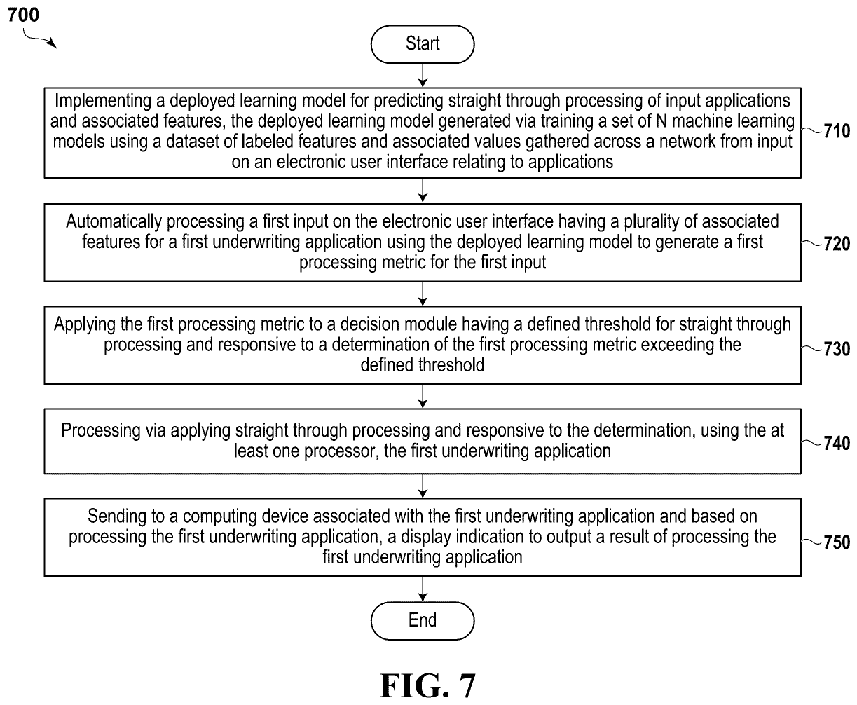

FIG. 7 is a flowchart that describes an example method of operations 700 that may be performed for example by some or all of the computing components (e.g. processor 110) and modules of the underwriting platform 102 of FIGS. 1-3B, according to some embodiments of the present disclosure. In some embodiments, at 710, the method may include implementing a deployed learning model for predicting straight through processing of input applications and associated features, the deployed learning model generated via training a set of N machine learning models using a dataset of labelled features and associated values gathered across a network from input on an electronic user interface relating to applications.

The operation 700 may be performed in response to an action associated with an entity of the computing system of FIG. 1, such as via the target computing device 108 or the underwriter terminals 128 to cause an automated proactive and real-time automated application processing for determination of straight through processing to be performed.

The methods described herein may be performed by hardware, software, or any combination of these approaches. For example, a computer-readable storage medium may store thereon instructions that when executed by a computerized machine result in operations according to any of the embodiments described herein.

In some embodiments, the labelled features of the application data using for the training/testing dataset (e.g. training/testing data 105) may indicate a processing metric for the dataset (e.g. straight through processing, declined processing, etc. based on historical annotated or labelled data used for model generation), the training/testing dataset (e.g. 105) is split into N folds (to match the number of models) for predicting straight through processing via the model generation module 250. The processor 110 is further configured to train each model of the set of machine learning models, via the model training module 252 on all but one fold of the dataset (k−1 fold) and testing on other remaining fold (1 fold) of the dataset. The models generated may be tested on non-overlapping datasets and repeated until all models may be trained and generated via the model training module 252. A resultant model providing the deployed learning model may be generated by aggregating results (e.g. via the model aggregation module 254) via model ensembling from training each model of the set of machine learning models. Model ensembling as performed by the at least one processor of the underwriting platform 102 combines the predictions or decisions from multiple individual models to produce a final prediction or decision. The ensemble learning system or resultant model comprises a plurality of machine learning models, each trained on a subset of training data (e.g. 105). During the prediction phase, the machine learning module 114 combines the predictions generated by the individual models using one or more ensemble techniques, such as voting, averaging, or stacking model results. The defined ensemble machine learning system provided by the machine learning module 114 thus enhances the accuracy, reliability, and robustness of predictions, making it suitable for diverse machine learning tasks, including but not limited to binary classification task of straight through processing of applications based on the specifically configured multiple machine learning models.

As described earlier, with reference to FIG. 2, the machine learning module 114 aims to optimize at least two different sets of parameters for the generated set of machine learning models: hyperparameters and model weights for each model in the set of models. The model weights are determining during training of the models via the model training module 252 of FIG. 2 applying the training/testing data (e.g. 105). As described earlier, during the training/testing phase of the models (e.g. training and evaluation phase 300), the incoming training/testing dataset (e.g. 105) is split into k equal parts and k number of models are trained (e.g. 5 models, data split into 80% training data 306, 20% testing data 308 for each run) such that for each model, the model is trained on k−1 segments and testing on the other one segment. Thus for in time results, each model may see 20% of the data and train on 80% of the data and once models are trained, the results being aggregated or averaged to generate the deployed machine learning model. On the other hand, as described earlier, hyperparameter optimization for the set of machine learning models which may be performed via the hyperparameter optimization module 258 is optimized using Bayesian optimization which is optimal for the lack of training/testing data 105. In both cases of hyperparameter optimization and model training for the model generation module 250 (e.g. as may be performed at step 710 of operation 700) as the proposed set of training/testing data 105 may be minimal and sparse (e.g. lack of sufficient labelled data and lack of consistent information in the data), a specialized training/testing of the machine learning models is envisaged whereby the training/testing data 105 set is split into k folds (e.g. 80-20 for 5 fold split) and the processor 110 is configured to train, via the model training module 252, k machine learning models which facilitate the improved generalization of the deployed model such as to the unseen data in the future and handling a lack of training data. Such k set of models as generated may be ensembled together for the inference stage by the machine learning module 114. As mentioned earlier, the trained models generated by the model generation module 250 (e.g. having been trained on labelled data with processing output classifications, e.g. standard, declined, or reduced processing) may provide an output number representative of a confidence score for straight through processing of the input application received in real time, whereby thresholds are applied via the threshold decision module 120 and threshold 111 to determine subsequent computerized actions for processing the transaction and whether straight through processing of the application under review should be triggered and to trigger one or more computing devices of the application processing system 100 to put into effect the straight through processing which may include data sharing, data transfers or e-commerce adjudication via the computing device across the network 106.

In some embodiments, at operation 720, the method may include automatically processing a first input of real time input application data on the electronic UI 121 of the target computing device 108 having a plurality of associated features for a first underwriting application using the deployed learning model to generate a first processing metric for the first input, the first processing metric indicative of a probability (e.g. between 0 and 1) of straight through processing, such that if this number is higher than a threshold it may be classified as straight through processing and appropriate computerized processing actions may be performed on the input application data. At operation 730 following operation 720, the method may include applying the first processing metric to a decision module (e.g. threshold decision module 120) having a defined threshold for straight through processing and responsive to a determination of the first processing metric exceeding the defined threshold, performing the subsequent steps.

In some embodiments, at operation 740 following operation 730, the method may include upon a positive determination of the first processing metric exceeding the defined threshold, processing via applying straight through processing, using the at least one processor 110, the first underwriting application. Subsequently at operation 750, the method may include sending, to a computing device associated with the first underwriting application (e.g. the target computing device 108 and user interface (UI) 121 for the underwriting API 126) and based on processing the first underwriting application, a display indication to output a result of processing the first underwriting application. Thus, responsive to the positive determination, the processor may cause one or more computing devices of the distributed system (e.g. as illustrated in the application processing system 100 of FIG. 1) to perform the straight through processing identified in the application (e.g. electronic transfer of information from one computing device to another, data sharing between computing devices, electronic payment settling or routing, exchange of information between a source and destination computing device, etc.). In at least some implementations, the result and associated details of the positive determination performed by the machine learning models and/or such straight through processing result may be submitted to the target computing device 108 requesting the application processing, such as for display on the user interface 121 for the relevant application program relating to the application request.

While this specification contains many specifics, these should not be construed as limitations, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow. Further, other embodiments will be apparent to those skilled in the art from consideration of the specification and practice of one or more embodiments of the present disclosure.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit.

One or more currently preferred embodiments have been described by way of example. It will be apparent to persons skilled in the art that a number of variations and modifications can be made without departing from the scope of the disclosure as defined in the claims.

1. An application processing system comprising:
at least one processor and at least one memory configured to implement a deployed learning model, the deployed learning model generated via training a set of N machine learning models using a dataset of labelled features and associated values gathered across a network from input on an electronic user interface relating to applications and wherein the labelled features indicates a processing metric for the dataset, the dataset split into N folds for predicting straight through processing, each model of the set of machine learning models is trained on all but one fold of the dataset and tested on other remaining fold of the dataset, wherein the models are tested on non-overlapping datasets and repeated until all models are trained wherein a resultant model providing the deployed learning model is generated by aggregating results via model ensembling from training each said model of the set of machine learning models, the at least one processor further configured to:
automatically process a first input on the electronic user interface having a plurality of associated features for a first underwriting application using the deployed learning model to generate a first processing metric for the first input; and
apply the first processing metric to a decision module having a defined threshold for straight through processing and responsive to the first processing metric exceeding the defined threshold, the at least one processor further configured to:
process via applying straight through processing, using the at least one processor, the first underwriting application; and
sending, to a computing device associated with the first underwriting application and based on processing the first underwriting application, a display indication to output a result of processing the first underwriting application.

2. The application processing system of claim 1, wherein during generating of the deployed learning model, the at least one processor is further configured to perform feature ablation to determine features of interest and ablate remaining features via k-fold cross validation using holdout of a selected feature at a time, wherein each model is tested on a single fold which it was not trained on while removing one feature at a given time from a training and testing dataset provided in the dataset of labelled features and aggregating results to determine performance of models trained on data with the one feature removed via a performance metric and applying a defined feature threshold to the performance metric to determine features of interest having a highest performance metric.

3. The application processing system of claim 2, wherein the at least one processor is further configured to perform hyperparameter optimization using k-fold cross validation performed after feature ablation on only non-ablated features.

4. The application processing system of claim 1, wherein the dataset of features is selected from at least one of: binary, categorical and numerical data input into the electronic user interface of an associated computing device accessing an application programming interface.

5. The application processing system of claim 1 wherein the at least one processor is further configured, to apply the first underwriting application to a rule based decisioning model to determine, via applying a defined set of rules to associated features of the dataset of the first underwriting application, an initial indication of whether to further process the first underwriting application via the deployed learning model; based upon a positive response for further processing, the at least one processor is configured to provide the first underwriting application to the deployed learning model for predicting straight through processing.

6. The application processing system of claim 1, wherein the at least one processor is further configured to train the set of machine learning models based on a new dataset of labelled features and compare performance to a prior iteration to determine which instance of the machine learning models to utilize based on increased relative performance.

7. The application processing system of claim 1, wherein the at least one processor is further configured to confirm validity of the deployed learning model by applying out of time data as a test set and averaging prediction results from each of the set of machine learning models to determine a prediction score.

8. The application processing system of claim 1, wherein each of the set of machine learning models utilizes a supervised extreme gradient boosted (XGBoost) model.

9. The application processing system of claim 1 wherein the set of machine learning models comprises 5 models and a same threshold is applied to all models to determine whether to apply straight through processing to the first underwriting application.

10. The application processing system of claim 3, wherein performing the hyperparameter optimization further comprises the at least one processor configured to apply Bayesian optimization for hyperparameter tuning of each said model of the set of machine learning models.

11. The application processing system of claim 1, wherein the at least one processor is configured to apply a plurality of decision trees via an XGBoost model to determine the defined threshold at the decision module.

12. The application processing system of claim 4, wherein the at least one processor further converts the first input on the electronic user interface to a comma separated value file having a similar format of features to the dataset of labelled features used for training the set of machine learning models prior to applying to the deployed learning model.

13. A computer implemented method comprising:
implementing a deployed learning model for predicting straight through processing of input applications and associated features, the deployed learning model generated via training a set of N machine learning models using a dataset of labelled features and associated values gathered across a network from input on an electronic user interface relating to applications and wherein the labelled features indicate a processing metric for the dataset, the dataset split into N folds for predicting straight through processing, and each model of the set of machine learning models is trained on all but one fold of the dataset and tested on other remaining fold of the dataset, wherein the models are tested on non-overlapping datasets and repeated until all models are trained and wherein a resultant model providing the deployed learning model is generated by aggregating results via model ensembling from training each said model of the set of machine learning models;
automatically processing a first input on the electronic user interface having a plurality of associated features for a first underwriting application using the deployed learning model to generate a first processing metric for the first input; and
applying the first processing metric to a decision module having a defined threshold for straight through processing and responsive to a determination of the first processing metric exceeding the defined threshold:
processing via applying straight through processing, using an application processing module, the first underwriting application; and
sending, to a computing device associated with the first underwriting application and based on processing the first underwriting application, a display indication to output a result of processing the first underwriting application.

14. The method of claim 13, wherein during generating of the deployed learning model, the method further comprises performing feature ablation to determine features of interest and ablate remaining features via k-fold cross validation using holdout of a selected feature at a time, wherein each model is tested on a single fold which it was not trained on while removing one feature at a time from a training and testing dataset and aggregating results to determine performance of models trained on data with the one feature removed via a performance metric and applying a defined feature threshold to the performance metric to determine features of interest having a highest performance metric.

15. The method of claim 14, further comprising performing hyperparameter optimization using k-fold cross validation performed after feature ablation on only non-ablated features.

16. The method of claim 14, wherein the dataset of features is selected from at least one of: binary, categorical and numerical data input into the electronic user interface of an associated computing device accessing an application programming interface.

17. The method of claim 14 further comprising applying the first underwriting application to a rule based decisioning model to determine, via applying a defined set of rules to associated features of the dataset of the first underwriting application, an initial indication of whether to further process the first underwriting application via the deployed learning model; based upon a positive response for further processing, providing the first underwriting application to the deployed learning model for predicting straight through processing.

18. The method of claim 13 further comprising: training the set of machine learning models based on a new dataset of labelled features and comparing performance to a prior iteration to determine which instance of the machine learning models to utilize based on increased relative performance.

19. The method of claim 13 further comprising confirming validity of the deployed learning model by applying out of time data as a test set and averaging prediction results from each of the set of machine learning models to determine a prediction score.

20. The method of claim 13, wherein each of the set of machine learning models utilizes a supervised extreme gradient boosted (XGBoost) model.

21. The method of claim 13 wherein the set of machine learning models comprises 5 models and a same threshold is applied to all models to determine whether to apply straight through processing to the first underwriting application.

22. The method of claim 15, wherein performing the hyperparameter optimization further comprises applying Bayesian optimization for hyperparameter tuning of each said model of the set of machine learning models.

23. The method of claim 13, further comprising applying a plurality of decision trees via an XGBoost model to determine the defined threshold at the decision module.

24. The method of claim 16, further comprising converting the first input on the electronic user interface to a comma separated value file having a similar format of features to the dataset of labelled features used for training the set of machine learning models prior to applying to the deployed learning model.
